(19) United States
(12) Patent Application Publication
(10) Pub. No.: US 2007/0264112 A1
(43) Pub. Date: Nov. 15, 2007

(54) AUGER LATCH

(75) Inventors: Lane Francis, Swift Current (CA); Wes Hiebert, Swift Current (CA); Terry Hiebert, Waldeck (CA); Rob Olson, Hodgeville (CA)

Correspondence Address: MYERS WOLIN, LLC, 100 HEADQUARTERS PLAZA, North Tower, 6th Floor, MORRISTOWN, NJ, 07960-6834, US

(73) Assignee: REM Manufacturing Ltd., Swift Current (CA)

(21) Appl. No.: 11/423,428

(22) Filed: Jun. 9, 2006

(30) Foreign Application Priority Data
May 15, 2006 (CA) 2546816

(51) Int. Cl. B60P 1/00

(52) U.S. Cl. 414/523

(57) ABSTRACT

An auger latch for securing an auger assembly of a bulk loader, and having a mounting plate with a locking pin thereon for attachment to the loader. The latch features spaced apart guide plates, which define a longitudinally extending opening for receiving the locking pin. A latch plate is pivotally secured to and positioned between the guide plates, the latch plate having a handle portion at one end thereof and a pin engaging portion at an opposite end. When the latch plate is in an unlocked position, the pin engaging portion extends into the opening defined by the guide plates. When the auger assembly is to be moved from a working position to a stowed position adjacent a sidewall of the loader, the locking pin is inserted into the opening of the guide plates to initially engage the pin engaging portion, and, as the locking pin continues to be inserted into the opening, the pin engaging portion biasingly retracts, permitting the locking pin to be inserted fully into the opening. Once the locking pin has been inserted fully, the pin engaging portion extends to assume a locked position securing the pin in place within the opening. Spring means connected to the guide plates and the handle portion enable the latch plate to move from the locked position to an unlocked position, whereby the locking pin can be removed.

### FIELD OF THE INVENTION

This invention relates to an auger latch for securing an auger assembly of a bulk loader, and, more particularly, to an auger latch for use in securing the auger assembly of a bulk loader to a storage position, or to prevent it from moving while transporting the bulk loader.

### DESCRIPTION OF THE PRIOR ART

Generally speaking, prior auger assemblies for bulk loaders include an elongated barrel or tube presenting a material inlet and a material outlet spaced from the inlet, with an elongated, axially rotatable, material-conveying auger screw positioned within the barrel or tube. Auger assemblies are often used in a bulk loader for conveying materials such as granular agricultural products along a desired path of travel, for example, from the outlet of a cyclone separator to a collection hopper. Such auger assemblies may be inclined upwardly and outwardly away from the body of the bulk loader, whereby, when the auger assembly is in a working position, particulate or granular materials are continuously advanced by the auger assembly upwardly and outwardly away from the body toward the outermost end of the barrel or tube for transferral to, for example, an awaiting truck or other receptacle.

As is known in the art, such elongated auger assemblies can be constructed in sections and, possibly, hinged in one or more locations along the barrel or tube, making the auger assembly collapsible, so as to enable an upper section of the barrel or tube to be folded back into overlapping relationship for roading or storage purposes. Of course, through such hinge a portion of an entire auger assembly can thus be retracted to a transport or storage condition (overlapping relationship, or overlapping relationship with the bulk loader) or expanded to an elongated, full line working condition.

However, when the auger assembly is not in use, and particularly when the auger assembly (and the bulk loader) is to be transported, it is important to firmly secure such an auger assembly to limit and/or prevent the movement thereof during transportation, so as to avoid any potential hazard and damage occurring to the auger assembly.

There is a further need for an improved auger latch which can act as a transport rest when the auger assembly is to be folded into a transport position, and which can latch the auger assembly in the transport or storage position to prevent or substantially inhibit it from moving while transporting the bulk loader and auger assembly. In this regard, the present invention substantially fulfills this need.

### SUMMARY OF THE INVENTION

Accordingly, one object of the present invention is to provide an improved auger latch for securing an auger assembly of a bulk loader, which can act as a transport rest when the auger assembly is to be folded into a transport position.

Another object of the present invention is to provide an improved auger latch which can prevent or substantially inhibit the auger assembly from moving while transporting the bulk loader and auger assembly.

A still further object of the present invention is to provide an improved auger latch which can be automatically engaged to secure the auger assembly, and which can be manually disengaged to release the auger assembly.

According to one aspect of the present invention, there is provided an auger latch for securing an auger assembly to a bulk loader comprising a mounting plate for attachment to the bulk loader, the mounting plate having a locking pin connected thereto; means for connecting the mounting plate to the bulk loader; means for receiving the locking pin, having a longitudinally extending opening defined at one end thereof, the means for receiving the locking pin being connected to the auger assembly; biasing means pivotally connected to and positioned parallel to the means for receiving the locking pin, the biasing means having a handle portion at one end thereof, whereby the biasing means extends into the longitudinally extending opening, whereby, when the auger assembly is to be moved from a working position extending outwardly from the bulk loader to a stowed position adjacent a sidewall of the bulk loader, the locking pin is inserted into the longitudinally extending opening to initially engage the biasing means, whereby, as the locking pin continues to be inserted into the longitudinally extending opening and is no longer in contact with the biasing means, the biasing means retracts, permitting the locking pin to be inserted fully into the longitudinally extending opening, wherein, once the locking pin has been inserted fully into the longitudinally extending opening, the biasing means extends to assume a locked position securing the locking pin in place within the longitudinally extending opening; and spring means connected to each of the means for receiving the locking pin and the handle portion, the spring means enabling the biasing means to move from the locked position to an unlocked position, whereby the locking pin can be removed.

According to another aspect of the present invention, there is provided an auger latch assembly for use with a bulk loader having an auger assembly for transferring granular or particulate materials to a remote location, comprising a mounting plate for attachment to the bulk loader, the mounting plate having a locking pin connected thereto; first and second spaced apart guide plates each having a closed end and an open end spaced from the closed end, the open end of the guide plates defining, when the guide plates are positioned in a corresponding manner, a longitudinally extending opening for receiving the locking pin; a spacer plate secured to and positioned between the closed end of the first and second spaced apart guide plates, one end of the spacer plate being connected to the auger assembly; a latch plate pivotally secured to and positioned between the guide plates, the latch plate being secured towards the open end of the guide plates, the latch plate having a handle portion at one end thereof and spaced apart first and second pin engaging portions at an opposite end, wherein, when the latch plate is in an unlocked position, the first pin engaging portion extends into the longitudinally extending opening defined by the guide plates, whereby, when the auger assembly is to be moved from a working position extending outwardly from the bulk loader to a stowed position adjacent a sidewall of the bulk loader, the locking pin is inserted into the longitudinally extending opening of the guide plates to initially engage the first pin engaging portion, whereby, as the locking pin continues to be inserted into the longitudinally extending opening and is no longer in contact with the first pin engaging portion, the first pin engaging portion biasingly retracts, permitting the locking pin to be inserted fully into the longitudinally extending opening, wherein, once the locking pin has been inserted fully into the longitudinally extending opening, the first pin engaging portion extends to assume a locked position securing the locking pin in place within the longitudinally extending opening; and spring means connected to at least one of the guide plates and the handle portion, the spring means enabling the latch plate to move from the locked position to an unlocked position, whereby the locking pin can be removed.

A still further aspect of the present invention provides for an auger latch assembly for use with a bulk loader having an auger assembly for transferring granular or particulate materials to a remote location, comprising a mounting plate for attachment to the bulk loader, the mounting plate having a locking pin connected thereto; first and second spaced apart guide plates each having a closed end and an open end spaced from the closed end, the open end of the guide plates defining, when the guide plates are positioned in a corresponding manner, a longitudinally extending opening for receiving the locking pin; a spacer plate secured to and positioned between the closed end of the first and second spaced apart guide plates, one end of the spacer plate being connected to the auger assembly; a latch plate pivotally secured to and positioned between the guide plates, the latch plate being secured towards the open end of the guide plates, the latch plate having a handle portion at one end thereof and spaced apart first and second end portions at an opposite end, wherein, when the latch plate is in an unlocked position, the first end portion extends into the longitudinally extending opening defined by the guide plates, whereby, when the auger assembly is to be moved from a working position extending outwardly from the bulk loader to a stowed position adjacent a sidewall of the bulk loader, the locking pin is inserted into the longitudinally extending opening of the guide plates to initially engage a contact surface of the latch plate, whereby, as the locking pin continues to be inserted into the longitudinally extending opening, the latch plate biasingly retracts, permitting the locking pin to be inserted fully into the longitudinally extending opening, wherein, once the locking pin has been inserted fully into the longitudinally extending opening, and is no longer in contact with the latch plate, the latch plate biasingly extends to assume a locked position, securing the locking pin in place within the longitudinally extending opening; and spring means connected to at least one of the guide plates and the handle portion, the spring means enabling the latch plate to move from the locked position to an unlocked position, whereby the locking pin can be removed.

The advantage of the present invention is that it provides an improved auger latch for securing an auger assembly of a bulk loader, which can act as a transport rest when the auger assembly is to be folded into a transport position.

A further advantage of the present invention is that it provides an improved auger latch which can prevent or substantially inhibit the auger assembly from moving while transporting the bulk loader and auger assembly.

Yet another advantage of the present invention is that it provides an improved auger latch which can be automatically engaged to secure the auger assembly, and manually disengaged to release the auger assembly.

### BRIEF DESCRIPTION OF THE DRAWINGS

A preferred embodiment of the present invention is described below with reference to the accompanying drawings, in which:

FIG. 1A is a side view of an embodiment of the auger latch of the present invention, which illustrates the securing pin being initially guided, by the guide plates, into position;

FIG. 1B is a continuation of the embodiment shown in FIG. 1A, and illustrates, as the securing pin continues toward the rear of the opening in the guide plates, the securing pin engaging and biasing upwardly the latch plate of the auger latch;

FIG. 1C is a continuation of the embodiment shown in FIG. 1B, and illustrates the securing pin moving into a final securement position between the guide plates;

FIG. 1D is a continuation of the embodiment shown in FIG. 1C, and illustrates the securing pin now placed in final securement position between the guide plates, whereby the latch plate of the auger latch has moved into a fully lowered position, locking the securing pin in position;

FIG. 2A is a side view of an embodiment of the auger latch of the present invention, which illustrates the beginning of the process to manually disengage the securing pin, whereby the latch plate is fully rotated away from the fully lowered position;

FIG. 2B is a continuation of the embodiment shown in FIG. 2A, and illustrates, as the securing pin continues to move towards the disengagement position, the securing pin engaging and biasing upwardly the latch plate of the auger latch;

FIG. 2C is a continuation of the embodiment shown in FIG. 2B, and illustrates the securing pin now having achieved a position of disengagement from the auger latch and guide plates and the latch plate of the auger latch has dropped into a fully lowered position, resetting the auger latch for future use; and

FIG. 3 is a partially exploded view of the auger latch of the present invention securing a hinged auger assembly for a bulk loader.

### DESCRIPTION OF THE PREFERRED EMBODIMENT

As is known in the art, because of their length, auger assemblies for bulk loaders can be hinged to enable one or more sections of the auger to be folded for roading purposes. To secure the auger to the bulk loader when the auger is in a folded configuration, the auger latch of the present invention may be utilized to securely engage the folded auger with the bulk loader.

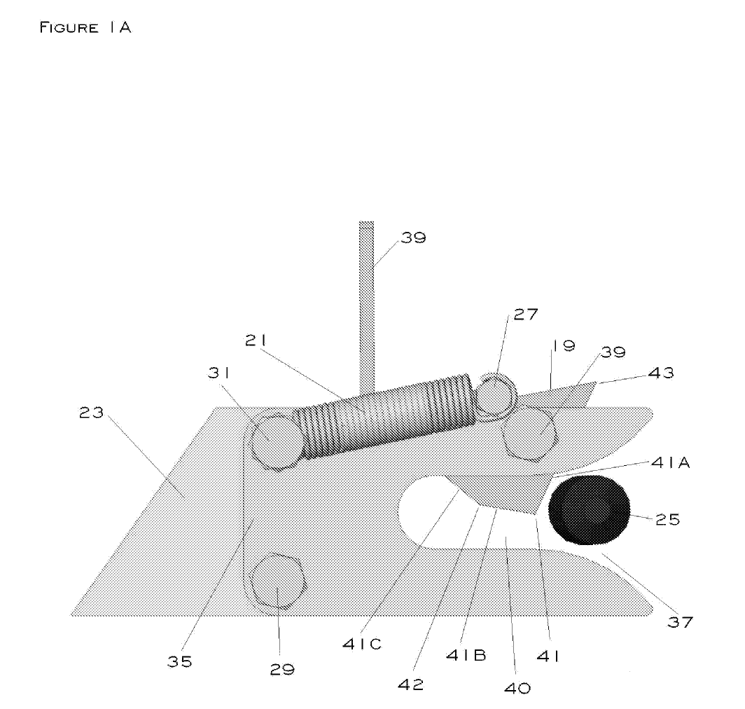

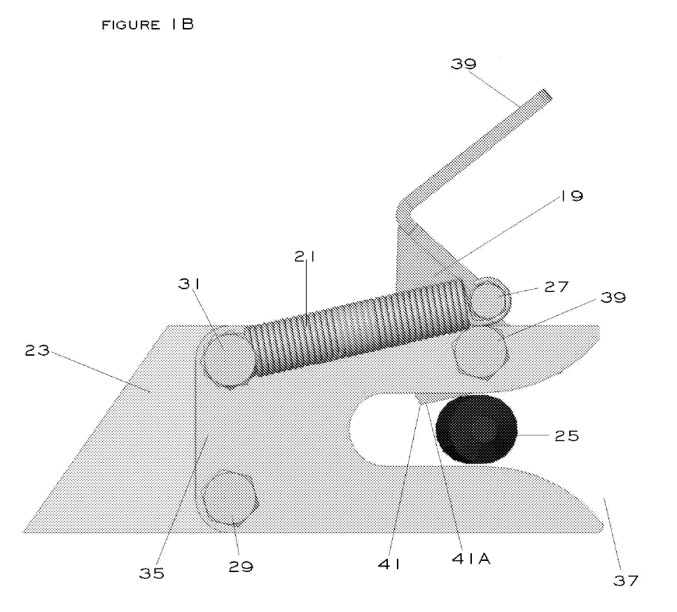

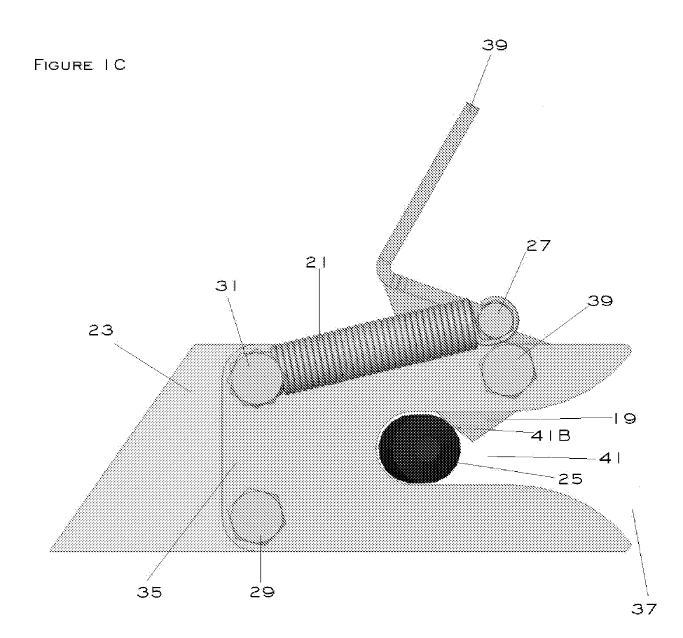

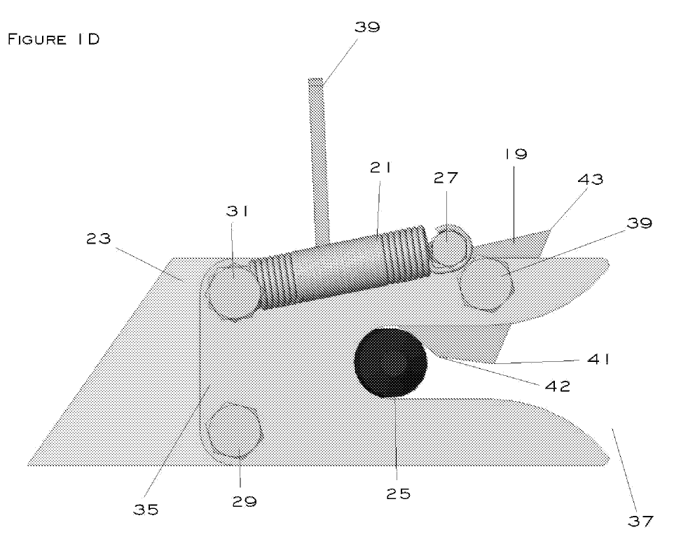

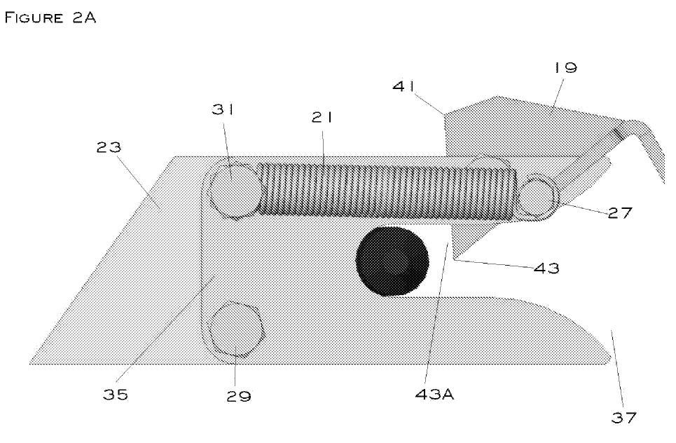

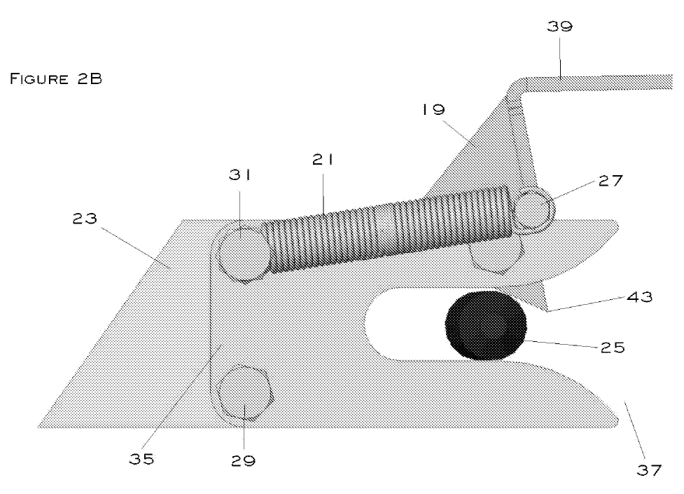

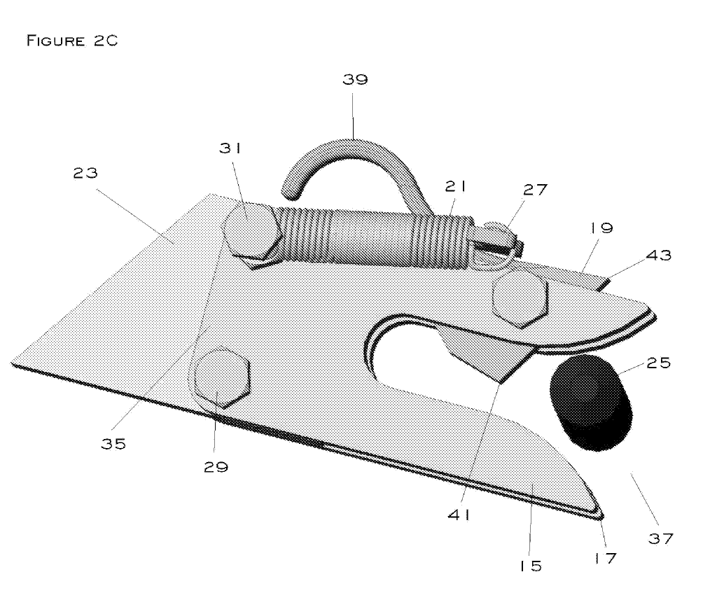

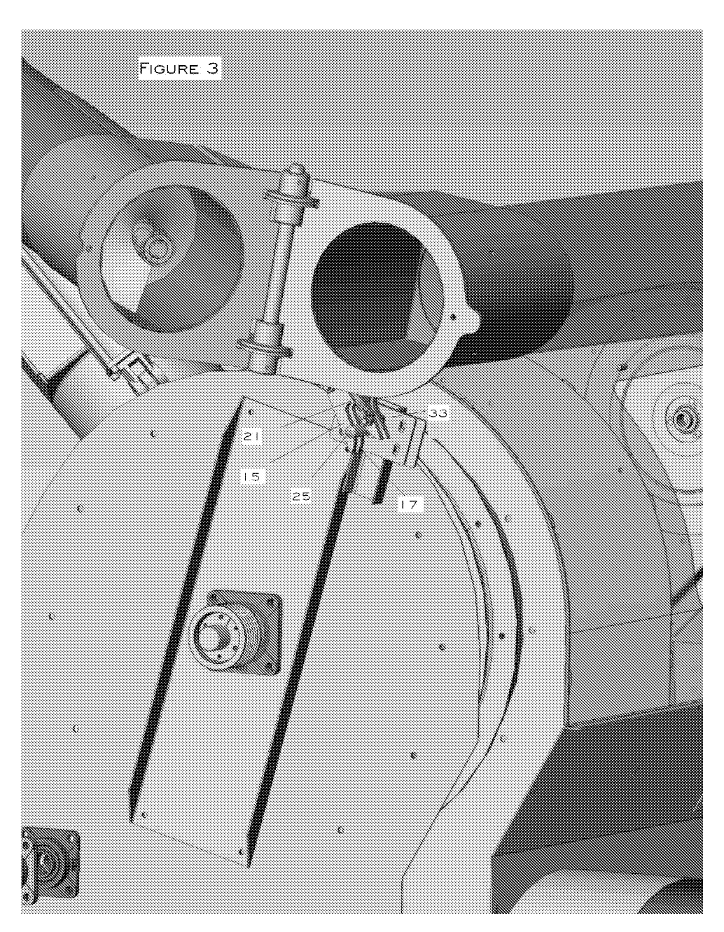

With reference to FIGS. 1A, 2A and 2C, and in a preferred embodiment, the auger latch of the present invention is made up of guide plates 15 and 17, a spacer plate 23, a latch plate 19 and a spring 21, it being understood that it may also be possible to utilize one guide plate instead of two guide plates. The guide plates 15 and 17 are, for example, bolted (at 29 and 31) or otherwise securely attached to a spacer plate 23 which is attached to the auger assembly 3, such connection being shown generally in FIG. 3. The connection of the spacer plate 23 to the auger assembly 3 can be accomplished by welding such plate to the auger assembly, for example, or bolted, or through other means which would be apparent to a worker skilled in the art. The other component of the auger latch consists of a locking pin 25 mounted, for example, to a mounting plate 33, which in turn is securely attached to the bulk loader, as seen in FIG. 3, such connection which may occur through welding, for example, or a bolted connection, or through other means which would be apparent to a worker skilled in the art. Of course, it will also be understood that the mounting plate 33 and locking pin 25, could in an alternative embodiment, be connected to the auger assembly, and the guide plates 15 and 17, spacer plate 23, latch plate 19 and spring 21 connected to the bulk loader.

The guide plates 15 and 17 are, in a preferred embodiment, spaced apart, and as can be seen in FIG. 2C, each guide plate 15 and 17 having a closed end, generally shown as 35 and an open end (generally shown as 37) spaced from the closed end 35, the open end 37 of the guide plates defining, when the guide plates are positioned in a corresponding manner (as shown in FIG. 3), a generally longitudinally extending opening 40 for receiving the locking pin 25. As is apparent in referencing FIGS. 1A-1D, the open end 37 of the guide plates 15 and 17 define, when the guide plates are positioned in a corresponding manner, a “U” shaped longitudinally extending opening 40 for receiving the locking pin 25, though it will be readily apparent that other similar configurations may be utilized, as would be apparent to a worker skilled in the art.

With reference to FIGS. 1A-1D and 3, a latch plate 19 is pivotally connected to (at 39) and positioned between the guide plates 15 and 17, the latch plate 19 being secured generally towards the open end 37 of the guide plates. The latch plate 19 preferably has a handle portion 39 at one end thereof, the opposite end thereof having spaced apart and opposed first 41 and third 43 end portions, as can be seen with reference to FIG. 1A. When the latch plate is in a fully lowered or locked position, as shown in FIG. 1A, first end portion 41 of the latch plate extends downwardly into the longitudinally extending opening 40 defined by the guide plates 15 and 17, and the third 43 end portion resides above the guide plates, as can be seen in FIG. 1A. Because of such pivotal connection of the latch plate 19 to the guide plates 15 and 17, the first 41 and third 43 end portions are biasingly movable, as hereinafter later described.

The spring 21 biases the latch plate 19 toward the fully lowered or locked position, as shown in FIG. 1A while the handle 39 allows the user to rotate the latch plate 19 against the bias of the spring 21 to a non-locked position. In one embodiment, a proximal end of the spring means 21 is attached around the bolted connection 31 of the first and second spaced apart guide plates, and a distal end of the spring means 21 is attached to the handle portion (at 27) as illustrated in FIG. 1A.

In using the auger latch of the present invention, and with reference to FIG. 1A, when the auger assembly is to be moved from the working position extending outwardly from the bulk loader to the stowed or transport position adjacent or proximate to the bulk loader, for example, the locking pin 25 is inserted into the longitudinally extending opening 40 to initially engage the first contact surface 41A of the latch plate 19 as illustrated in FIG. 1A. As the locking pin 25 is inserted into the longitudinally extending opening 40, the locking pin 25 pushes against the first contact surface 41A of the latch plate 19, and as illustrated in FIG. 1B, as the locking pin 25 continues to be inserted into the longitudinally extending opening 40, the locking pin 25 continues to push against the first contact surface 41A causing the entire latch plate 19 to rotate about the pivot 39 until the uppermost surface of the locking pin 25 is inserted past the first end portion 41 of the latch plate. As the locking pin 25 continues to be inserted into the longitudinally extending opening 40 past the point where the uppermost surface of the locking pin 25 is inserted past the first end portion 41 of the latch plate, as can be seen in FIG. 1C, the spring, acting on the latch plate, maintains contact between the latch plate 19 and the pin 25 along the second contact surface 41B, allowing the latch plate 19 to pivotally rotate toward a locked position.

As the locking pin 25 continues to be inserted, the uppermost surface of the locking pin 25 is inserted past the second end portion 42 of the latch plate and reaches the rear of the opening in the guide plates 15 and 17, as illustrated in FIG. 1D, the spring fully rotates the latch plate 19 to a locked position with the locking surface 41C of the latch plate proximate to and preferably in contact with the locking pin 25. With the locking pin 25 fully inserted in the longitudinally extending opening 40 and the latch plate in the fully lowered locking position as illustrated in FIG. 1D, the locking pin 25 is secured in the auger latch until the latch plate 19 is disengaged, as described hereinafter.

As can be seen in FIGS. 1A, 1B, 1C and 1D, the handle portion 39, which is attached to the latch plate 19, rotates correspondingly with the latch plate 19.

To disengage, or unlock the locking pin 25, the handle 39 on the latch plate 19 is rotated fully towards and over the open end of the guide plates 15 and 17, as seen in FIG. 2A, and, once the latch plate 19 reaches a certain point in its rotation against the spring pressure, the spring mount “over centres” (that is, the while the latch plate 19 is being rotated away from the locked position illustrated in FIG. 1D, the spring 21 is stretched, until it stretches to a maximum length which is generally achieved when the spring 21 is substantially aligned with the pivot 39, and as rotation of the latch plate 19 continues, the spring begins to shorten) and the latch plate 19 is temporarily positioned in an “unlatched” state as illustrated in FIG. 2A. It can be seen in FIG. 2A that the third end portion 43 of the latch plate 19 now extends into the longitudinally extending opening 40. As the locking pin 25 is disengaged from the longitudinally extending opening 40, it contacts the disengagement surface 43A (which in the preferred embodiment is an extension of surface 41A), and, as seen in FIG. 2B, the third end portion 43 biasingly retracts, once again over centering the spring mount, permitting the continued rotation of the latching plate 19 so that it no longer impedes the removal of the locking pin 25, thereby allowing for full removal of the locking pin 25 from the longitudinally extending opening 40, the spring automatically returning the latching plate 19 to the position shown in FIG. 2C. In this position, the latching plate 19 has been reset and is positioned once again for receiving and subsequently locking a locking pin when required and as previously described herein.

It can be seen that as a consequence of this “unlocking” action, and through the pivotal connection of the latch plate 19 at 39 between the guide plates 15, 17, the latch plate pivots as the pin is removed, whereby the handle portion 39 returns from the position over the open end of the guide plates 15 and 17 towards the closed end 35 of the guide plates 15 and 17, as seen in FIG. 2C. As such, once the locking pin 25 has been removed fully from the longitudinally extending opening 40, the first end portion 41 extends downwardly into the longitudinally extending opening defined by the guide plates 15 and 17, and the third end portion 43 is rotatingly retracted therefrom to a position above the guide plates.

The present invention has been described herein with regard to preferred embodiments. However, it will be obvious to persons skilled in the art that a number of variations and modifications can be made without departing from the scope of the invention as described herein.

What is claimed is:

1. An auger latch for securing an auger assembly to a bulk loader comprising:
a mounting plate for attachment to the bulk loader, the mounting plate having a locking pin connected thereto;
means for connecting the mounting plate to the bulk loader;
means for receiving the locking pin, having a longitudinally extending opening defined at one end thereof, the means for receiving the locking pin being connected to the auger assembly;
biasing means pivotally connected to and positioned parallel to the means for receiving the locking pin, the biasing means having a handle portion at one end thereof, whereby the biasing means extends into the longitudinally extending opening, whereby, when the auger assembly is to be moved from a working position extending outwardly from the bulk loader to a stowed position adjacent a sidewall of the bulk loader, the locking pin is inserted into the longitudinally extending opening to initially engage the biasing means, whereby, as the locking pin continues to be inserted into the longitudinally extending opening, the biasing means retracts, permitting the locking pin to be inserted fully into the longitudinally extending opening, wherein, once the locking pin has been inserted fully into the longitudinally extending opening and is no longer in contact with the biasing means, the biasing means extends to assume a locked position securing the locking pin in place within the longitudinally extending opening; and
spring means connected to each of the means for receiving the locking pin and the handle portion, the spring means enabling the biasing means to move from the locked position to an unlocked position, whereby the locking pin can be removed.

2. The auger latch of claim 1, wherein the means for receiving the locking pin comprises first and second spaced apart guide plates each having a closed end and an open end spaced from the closed end, the open end of the guide plates defining, when the guide plates are positioned in a corresponding manner, the longitudinally extending opening for receiving the locking pin.

3. The auger latch of claim 2, wherein the biasing means comprises a latch plate pivotally secured to and positioned between the guide plates, the latch plate being secured towards the open end of the guide plates, the latch plate having the handle portion at one end thereof and spaced apart first and third end portions at an opposite end, wherein, when the latch plate is in an unlocked position, the first end portion extends into the longitudinally extending opening defined by the guide plates, whereby, when the auger assembly is to be moved from the working position extending outwardly from the bulk loader to the stowed position adjacent a sidewall of the bulk loader, the locking pin is inserted into the longitudinally extending opening of the guide plates to initially engage a contact surface of the latch plate, whereby, as the locking pin continues to be inserted into the longitudinally extending opening, the contact surface of the latch plate biasingly retracts, permitting the locking pin to be inserted fully into the longitudinally extending opening, wherein, once the locking pin has been inserted fully into the longitudinally extending opening, and is no longer in contact with the contact surface of the latch plate, the latch plate extends to assume the locked position.

4. The auger latch of claim 3, wherein the first and second spaced apart guide plates are connected to a spacer plate, one end of the spacer plate being secured to, and positioned between, the closed end of each of the first and second spaced apart guide plates, and another end of the spacer plate being connected to the auger assembly.

5. The auger latch of claim 4, wherein the closed end of each of the first and second spaced apart guide plates are bolted to the one end of the spacer plate positioned therebetween.

6. The auger latch of claim 1, wherein the means for connecting the mounting plate to the bulk loader comprises nuts and bolts.

7. The auger latch of claim 2, wherein the open end of the guide plates define, when the guide plates are positioned in a corresponding manner, a “U” shaped longitudinally extending opening for receiving the locking pin.

8. The auger latch of claim 5, wherein a proximal end of the spring means is attached to the bolted connection of the first and second spaced apart guide plates to the one end of the spacer plate, and a distal end of the spring means is attached to the handle portion.

9. The auger latch of claim 3, wherein, when the locking pin is to be removed from the longitudinally extending opening to disengage the auger assembly from the stowed position, the handle portion is rotated towards and over the open end of the guide plates to assume the unlocked position, whereby the third end portion of the latch plate extends into the longitudinally extending opening while the first end portion retracts therefrom, and, as the locking pin continues to be disengaged from the longitudinally extending opening and contacts a disengaging surface of the latch plate, the latch plate biasingly retracts, permitting the locking pin to be removed fully from the longitudinally extending opening.

10. The auger latch of claim 9, wherein, as the latch plate biasingly retracts, the handle portion returns from the position over the open end of the guide plates towards the closed end of the guide plates, whereby, once the locking pin has been removed fully from the longitudinally extending opening, and is not in contact with the disengaging surface of the latch plate, the first end portion of the latch plate extends into the longitudinally extending opening, and the third end portion of the latch plate is rotatingly retracted therefrom.

11. An auger latch assembly for use with a bulk loader having an auger assembly for transferring granular or particulate materials to a remote location, comprising:
a mounting plate for attachment to the bulk loader, the mounting plate having a locking pin connected thereto;
at least one guide plate having a longitudinally extending opening defined at one end thereof for receiving the locking pin;
means for connecting the at least one guide plate to the auger assembly;
a latch plate pivotally connected to and positioned parallel to the at least one guide plate, the latch plate having a handle portion at one end thereof and a pin engaging portion at an opposite end, whereby the pin engaging portion extends into the longitudinally extending opening of the at least one guide plate, whereby, when the auger assembly is to be moved from a working position extending outwardly from the bulk loader to a stowed position adjacent a sidewall of the bulk loader, the locking pin is inserted into the longitudinally extending opening of the at least one guide plate to initially engage the pin engaging portion, whereby, as the locking pin continues to be inserted into the longitudinally extending opening, the pin engaging portion biasingly retracts, permitting the locking pin to be inserted fully into the longitudinally extending opening, wherein, once the locking pin has been inserted fully into the longitudinally extending opening, and is no longer in contact with the pin engaging portion, the pin engaging portion biasingly extends to assume a locked position securing the locking pin in place within the longitudinally extending opening; and
spring means connected to each of the at least one guide plate and the handle portion, the spring means enabling the latch plate to move from the locked position to an unlocked position, whereby the locking pin can be removed.

12. An auger latch assembly for use with a bulk loader having an auger assembly for transferring granular or particulate materials to a remote location, comprising:
a mounting plate for attachment to the bulk loader, the mounting plate having a locking pin connected thereto;
first and second spaced apart guide plates each having a closed end and an open end spaced from the closed end, the open end of the guide plates defining, when the guide plates are positioned in a corresponding manner, a longitudinally extending opening for receiving the locking pin;
a spacer plate secured to and positioned between the closed end of the first and second spaced apart guide plates, one end of the spacer plate being connected to the auger assembly;
a latch plate pivotally secured to and positioned between the guide plates, the latch plate being secured towards the open end of the guide plates, the latch plate having a handle portion at one end thereof and spaced apart first and third end portions at an opposite end, wherein, when the latch plate is in an unlocked position, the first end portion extends into the longitudinally extending opening defined by the guide plates, whereby, when the auger assembly is to be moved from a working position extending outwardly from the bulk loader to a stowed position adjacent a sidewall of the bulk loader, the locking pin is inserted into the longitudinally extending opening of the guide plates to initially engage a contact surface of the latch plate, whereby, as the locking pin continues to be inserted into the longitudinally extending opening, the latch plate biasingly retracts, permitting the locking pin to be inserted fully into the longitudinally extending opening, wherein, once the locking pin has been inserted fully into the longitudinally extending opening, and is no longer in contact with the latch plate, the latch plate biasingly extends to assume a locked position, securing the locking pin in place within the longitudinally extending opening; and
spring means connected to at least one of the guide plates and the handle portion, the spring means enabling the latch plate to move from the locked position to an unlocked position, whereby the locking pin can be removed.

13. The auger latch assembly of claim 12, wherein the closed end of each of the first and second spaced apart guide plates are bolted to the one end of the spacer plate positioned therebetween.

14. The auger latch assembly of claim 13, wherein the one end of the spacer plate is connected to the auger assembly by welding, or connected by nuts and bolts.

15. The auger latch assembly of claim 12, wherein the open end of the guide plates define, when the guide plates are positioned in a corresponding manner, a “U” shaped longitudinally extending opening for receiving the locking pin.

16. The auger latch assembly of claim 13, wherein a proximal end of the spring means is attached to the bolted connection of the first and second spaced apart guide plates to the one end of the spacer plate, and a distal end of the spring means is attached to the handle portion.

17. The auger latch assembly of claim 12, wherein, when the locking pin is to be removed from the longitudinally extending opening to disengage the auger assembly from the stowed position, the handle portion is rotated towards and over the open end of the guide plates to assume the unlocked position, whereby the third end portion of the latch plate extends into the longitudinally extending opening while the first end portion of the latch plate retracts therefrom, and, as the locking pin continues to be disengaged from the longitudinally extending opening and contacts a disengagement surface of the latch plate, the latch plate biasingly retracts, permitting the locking pin to be removed fully from the longitudinally extending opening.

18. The auger latch assembly of claim 17, wherein, as the latch plate biasingly retracts, the handle portion returns from the position over the open end of the guide plates towards the closed end of the guide plates, whereby, once the locking pin has been removed fully from the longitudinally extending opening, the first end portion of the latch plate extends into the longitudinally extending opening, and the third end portion of the latch plate is rotatingly retracted therefrom.
